(19) United States
(12) Patent Application Publication
(10) Pub. No.: US 2017/0269683 A1
(43) Pub. Date: Sep. 21, 2017

(54) DISPLAY CONTROL METHOD AND DEVICE

(71) Applicant: FUJITSU LIMITED, Kawasaki-shi (JP)

(72) Inventors: Takafumi SEGAWA, Osaka (JP); Takeyoshi AOYAMA, Uji (JP); SUSUMU FUJIWARA, NISHINOMIYA (JP); Yukinobu FUJII, Toyonaka (JP)

(73) Assignee: FUJITSU LIMITED, Kawasaki-shi (JP)

(21) Appl. No.: 15/456,645

(22) Filed: Mar. 13, 2017

(30) Foreign Application Priority Data
Mar. 17, 2016 (JP) 2016-054538

(51) Int. Cl. G06F 3/01; G06Q 30/02; G06F 3/0484

(52) U.S. Cl. CPC G06F 3/013; G06F 3/04842; G06F 3/012; G06Q 30/0272; G06Q 30/0261

(57) ABSTRACT

A computer-implemented method includes receiving a request from a user for a first product via a terminal installed on a place, allocating identification information to the user, tracking a user movement of the user during a time period between when the request is received and when the first product is provided to the user, identifying a second product that interests the user based on the tracked user movement, a plurality of product including the second product being presented to the user during the time period, associating the second product that interest the user with the identification information, and controlling a display device to display information regarding the second product, the display device being allocated to the identification information of the user.

### CROSS-REFERENCE TO RELATED APPLICATION

This application is based upon and claims the benefit of priority of the prior Japanese Patent Application No. 2016-054538, filed on filed on Mar. 17, 2016, the entire contents of which are incorporated herein by reference.

### FIELD

The embodiments discussed herein are related to a technique for controlling notification.

### BACKGROUND

Techniques for detecting an interest in an advertisement of various products are used for marketing. For example, as an example of a technique for detecting an interest in an advertisement, an image of a product corresponding to the gazing point of a user is moved to a center position or highlighted among the images of a plurality of products included in a display screen. As another example, an interest level of a person viewing a display image is obtained by a comparison between a display time of the image displayed on a display surface, and a person detection time in which the person is detected in a predetermined sensitivity area disposed on the front side of the display surface during the display time.

Related art techniques are disclosed, for example, in Japanese Laid-open Patent Publication Nos. 2012-22589, 2015-45733, and 2005-128929, and the like.

### SUMMARY

According to an aspect of the invention, a computer-implemented method includes receiving a request from a user for a first product via a terminal installed on a place, allocating identification information to the user, tracking a user movement of the user during a time period between when the request is received and when the first product is provided to the user, identifying a second product that interests the user based on the tracked user movement, a plurality of product including the second product being presented to the user during the time period, associating the second product that interest the user with the identification information, and controlling a display device to display information regarding the second product, the display device being allocated to the identification information of the user.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a configuration of a window reception system according to a first embodiment;

FIG. 2 is a schematic diagram illustrating an outer view of a reception machine;

FIG. 3 is a diagram illustrating a display example of advertisement content regarding products;

FIG. 4 is a diagram illustrating a display example of advertisement content regarding products;

FIG. 5 is a block diagram illustrating a functional configuration of a server device according to the first embodiment;

FIG. 6 is a diagram illustrating an example of reception data;

FIG. 7 is a diagram illustrating an example of interest data;

FIG. 8 is a diagram illustrating an example of notification data;

FIG. 9 is a diagram illustrating a sequence of reception control processing according to the first embodiment;

FIG. 10 is a flowchart illustrating a procedure of interest detection processing according to the first embodiment;

FIG. 11 is a flowchart illustrating a procedure of association processing according to the first embodiment;

FIG. 12 is a flowchart illustrating a procedure of notification control processing according to the first embodiment;

FIG. 13 is a block diagram illustrating a functional configuration of a server device according to a second embodiment;

FIG. 14 is a diagram illustrating an example of an image coordinate system of a wide angle camera;

FIG. 15 is a diagram illustrating an example of flow line data;

FIG. 16 is a diagram illustrating an example of an area of interest;

FIG. 17 is a diagram illustrating an example of interest detection;

FIG. 18 is a flowchart illustrating a procedure of management processing of flow line data, according to the second embodiment;

FIG. 19 is a flowchart illustrating a procedure of association processing according to the second embodiment; and

FIG. 20 is a diagram illustrating an example of a hardware configuration of a computer that executes a notification control program according to the first to third embodiments.

### DESCRIPTION OF EMBODIMENTS

Incidentally, a financial institution has a demand for promoting window sales to customers who have visited its sales offices. In order to realize such window sales, various efforts are made at the financial institution, for example, products are displayed on a display unit disposed in a waiting room, such as a lobby in a sales office, or the like, or the products are exhibited on a wall-mounted advertisement so as to attract attention of customers who are waiting their turn at a window.

Accordingly, it is thought that an advertisement of a product that interested a customer is detected in the stage for the customer waiting his or her turn at a window by applying the above-described technique.

However, with the above-described technique, even if a customer who is waiting time at a window has an interest in a product, it is difficult to link the situation to window sales.

That is to say, when window sales are carried out, there is a time difference between a point in time when a customer views an advertisement of a product and a point in time when the customer appears at a window. Accordingly, even when the above-described technique is applied, it is difficult to identify which customer has been interested in the advertisement of a product among the customers who are waiting their turn at a window. Further, there is usually a plurality of windows disposed in a sales office of a financial institution. Thus even if a customer having been interested in the advertisement of a product is identified among the customers who are waiting their turn at a window, it is difficult to identify at which window the customer will appear. It is therefore difficult to link the situation to window sales even if a customer has been interested in a product during a waiting time at a window with the above-described technique.

According to an aspect of the technique disclosed in the embodiments, it is desirable to link a product that interested a customer during waiting time at a window with window sales.

In the following, a description will be given of a notification control program, a notification control method, and a notification control device according to the present disclosure with reference to the accompanying drawings. In this regard, the embodiments will not limit the disclosed technique. It is possible to combine each of the embodiments within a range in which no contradiction occurs in the processing contents.

### First Embodiment

System Configuration

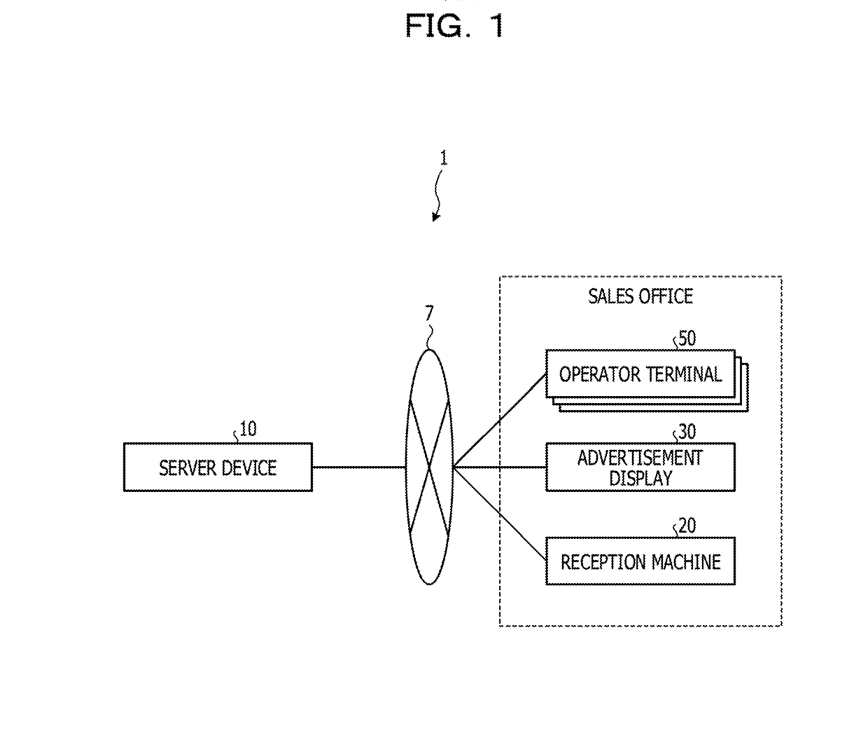

FIG. 1 is a diagram illustrating a configuration of a window reception system according to a first embodiment. A window reception system 1 illustrated in FIG. 1 provides a window reception service that receives turn waiting at a window of a financial institution, such as a bank, a Shinkin bank, a credit association, or the like. As part of such a window reception service, the window reception system aims to link a product that interested a customer during waiting time at the window with window sales.

As illustrated in FIG. 1, the window reception system 1 includes a server device 10, a reception machine 20, an advertisement display 30, and a plurality of operator terminals 50. Among these, the reception machine 20, the advertisement display 30 and the plurality of operator terminals 50 are disposed in a sales office of a financial institution, for example. In this regard, although the example in which the server device 10 is installed outside the sales office is illustrated in FIG. 1, there is no limitation regarding the installation place of the server device 10 so that it is possible to install the server device 10 at any place including the inside of the sales office.

The server device 10, the reception machine 20, the advertisement display 30, and the plurality of operator terminals 50 are coupled in a mutually communicable manner via a network 7. It is possible to employ any type of communication network, such as the Internet, a local area network (LAN), a Virtual Private Network (VPN), or the like for such the network 7 regardless of whether it is wired or wireless.

The server device 10 is a computer that provides the above-described window reception services.

As an embodiment, the server device 10 may be implemented as a Web server that realizes the above-described window reception services. Alternatively, it is possible to implement the above-described window reception services as a cloud service provided by outsourcing. Also, it is possible to implement the server device 10 by preinstalling or installing a window reception program provided as package software or online software to a desired computer.

The reception machine 20 is a device that issues a number ticket for a customer who has visited the sales office to get his or her waiting turn at a window, and is a so-called Eye-Que (EQ).

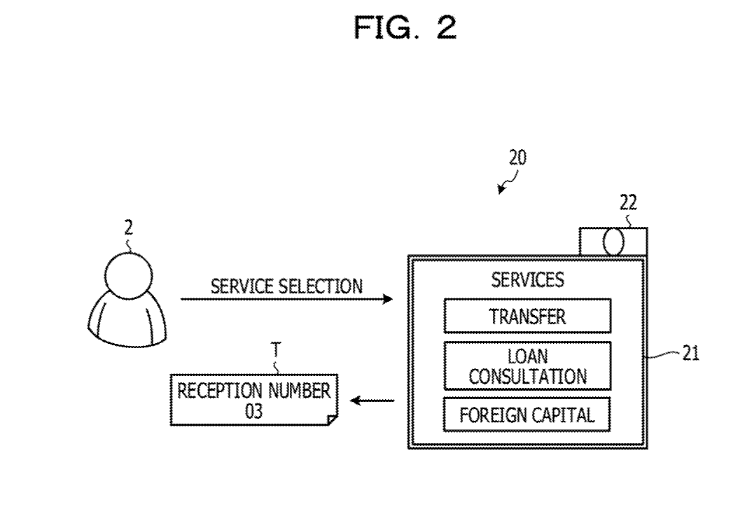

As an embodiment, the reception machine 20 is provided with a touch panel 21 and a camera 22 as illustrated in FIG. 2 in addition to a print out unit that issues a number ticket. FIG. 2 is a schematic diagram illustrating an outer view of the reception machine 20. Here, the touch panel 21 is formed at the position facing the face of a customer 2 who views or operates the screen, and the camera 22 is implemented as an in-camera at the position that falls within a range of capturing particularly the face portion of the customer 2 who is facing the screen of the touch panel 21. In such a configuration, the reception machine 20 waits for a reception event regarding waiting one's turn at a window in a state of displaying a service selection screen for selecting various services on the touch panel 21. When any one of the plurality of services is selected on the service selection screen, the reception machine 20 transmits the occurrence of the reception event to the server device 10. In response to this, the server device 10 issues an image capturing instruction to the reception machine 20. The reception machine 20 then performs shutter control of the camera 22, and captures the image of the customer 2 who stands in front of the screen of the touch panel 21. Moreover, the reception machine 20 increments the number of people waiting at the window, and issues a number ticket T on which a reception number “3” corresponding to the number of waiting people after the incrementation is printed. In this manner, the reception machine 20 obtains an image including the face portion of the customer 2 who has received his or her waiting turn at a window simultaneously with the issue of the number ticket T. In the following, the image captured by the camera 22 of the reception machine 20 is sometimes described as a “face image”. After that, the reception machine 20 uploads the reception number, the service, and the face image to the server device 10 via the network 7.

The advertisement display 30 is a display device installed for the advertisement of a product.

As an embodiment, it is possible to employ a liquid crystal display, an organic electroluminescence (EL) display, or the like for the advertisement display 30. The advertisement display 30 displays advertisement content regarding a product in accordance with an instruction from the server device 10. Further, the advertisement display 30 has a small-sized built-in sensor around the screen of the advertisement display 30. Such a small-sized sensor is provided with a microcomputer, a near-infrared LED, a small-sized camera, or the like. For example, the microcomputer applies an algorithm, such as a corneal reflection method, or the like to the image every time an image is obtained from the in-camera. Specifically, the microcomputer detects a sight line direction that connects the center position of an elliptical pupil of an eyeball and the center of curvature of the cornea from the image obtained from the in-camera, namely a so-called sight line vector. The microcomputer then calculates the sight line position on the screen of the advertisement display 30 from the sight line vector detected before, for example the coordinates of the screen, and uploads the sight line position to the server device 10.

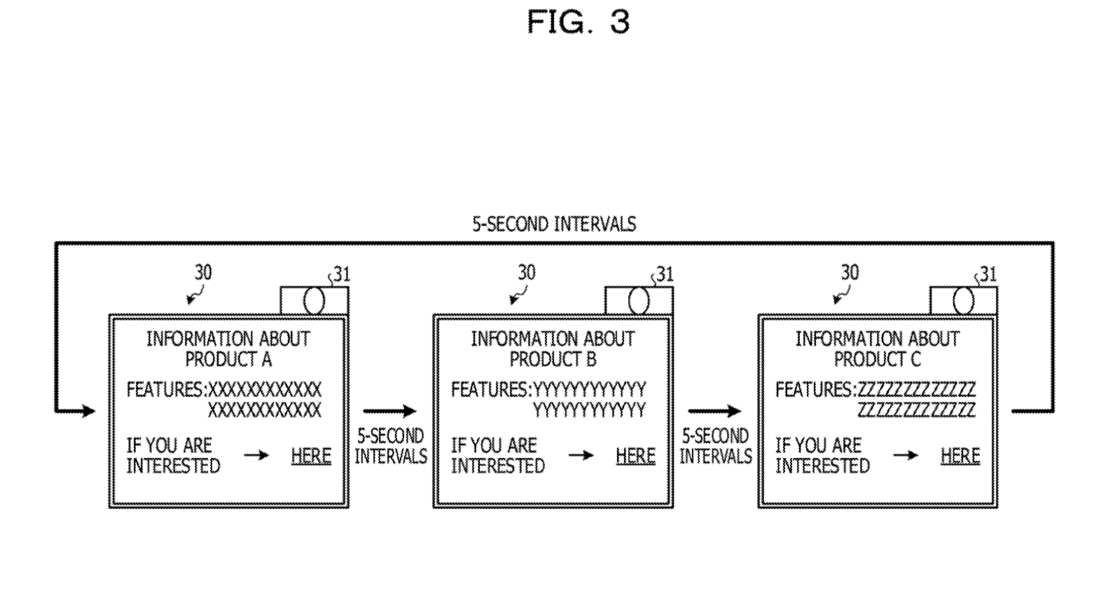

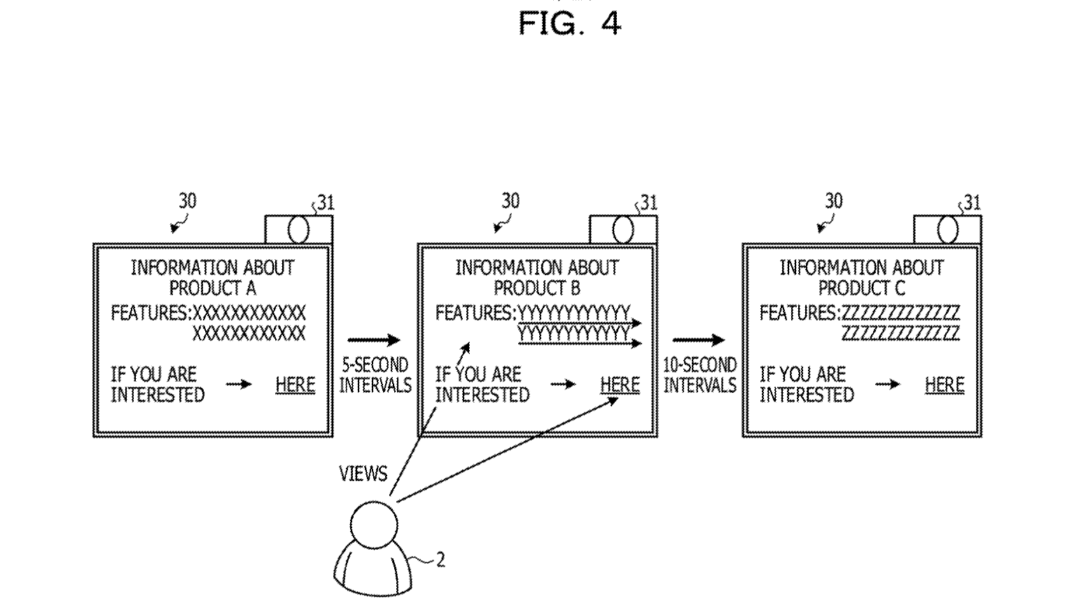

In this manner, the sight line position is uploaded to the server device 10 so that it is possible to effectively realize display control of the advertisement content regarding the product. FIG. 3 and FIG. 4 are diagrams illustrating a display example of advertisement content on products. In FIG. 3 and FIG. 4, an example in which one product is advertised by one display so that advertisement content that is circulated in order of A product, B product, C product, and A product is displayed with time, for example. As illustrated in FIG. 3, under the circumstance that a small-sized sensor 31 has not detected a sight line position on the screen of the advertisement display 30, the advertisement content regarding one product is changed at intervals of 5 seconds in accordance with display control of the server device 10.

On the other hand, as illustrated in FIG. 4, it is possible to extend the display period of the advertisement content regarding B product of interest in the case where a sight line position is detected on the screen of the advertisement display 30 by the small-sized sensor 31 at the stage when the advertisement content regarding B product is displayed, or in the case where a sight line position is detected in an area of interest set on the advertisement content, that is to say, a display area of the character string “Here” in FIG. 4. For example, while the advertisement content regarding B product is supposed to be changed to the advertisement content regarding C product in 5 seconds after the advertisement content regarding B is displayed on the advertisement display 30, the display period of the advertisement content regarding B product is extended for 5 seconds so that the display period of the advertisement content regarding B product becomes 10 seconds. Thereby, it is possible to reduce the situation in which advertisement content is changed before a customer 2 becomes interested in the advertisement content after the customer 2 turned his or her eyes to advertisement content.

An operator terminal 50 is a terminal device used by an operator at a window, namely a so-called teller.

As an embodiment, the operator terminal 50 is disposed for each window disposed at a sales office. For example, the operator terminal 50 receives input of a transaction type, a transaction amount, and the like in accordance with the slip filled by a customer, and capable of requesting online processing regarding the transaction to an accounting system not illustrated in FIG. 4. The operator terminal 50 is coupled to a cash processing machine for a teller, not illustrated in FIG. 4, and is capable of depositing and withdrawing money in accordance with the amount of receiving or payment that is received from the operator terminal 50 while performing storage management of the amount of money or the number of denominations that are contained in the storage unit of the cash processing machine. In this manner, the operator terminal 50 functions as a window of various financial transactions. Further, a peripheral device, such as a number display device, a number calling operation device, and the like that are not illustrated in FIG. 4 are coupled to the operator terminal 50. Among these, a reception number of a number ticket issued to a customer whom the operator is taking care of is displayed on the number display device. The number display device updates the reception number being displayed to the beginning reception number in the queue by receiving a calling operation of a reception number on the number calling operation device as an example.

Configuration of the Server Device 10

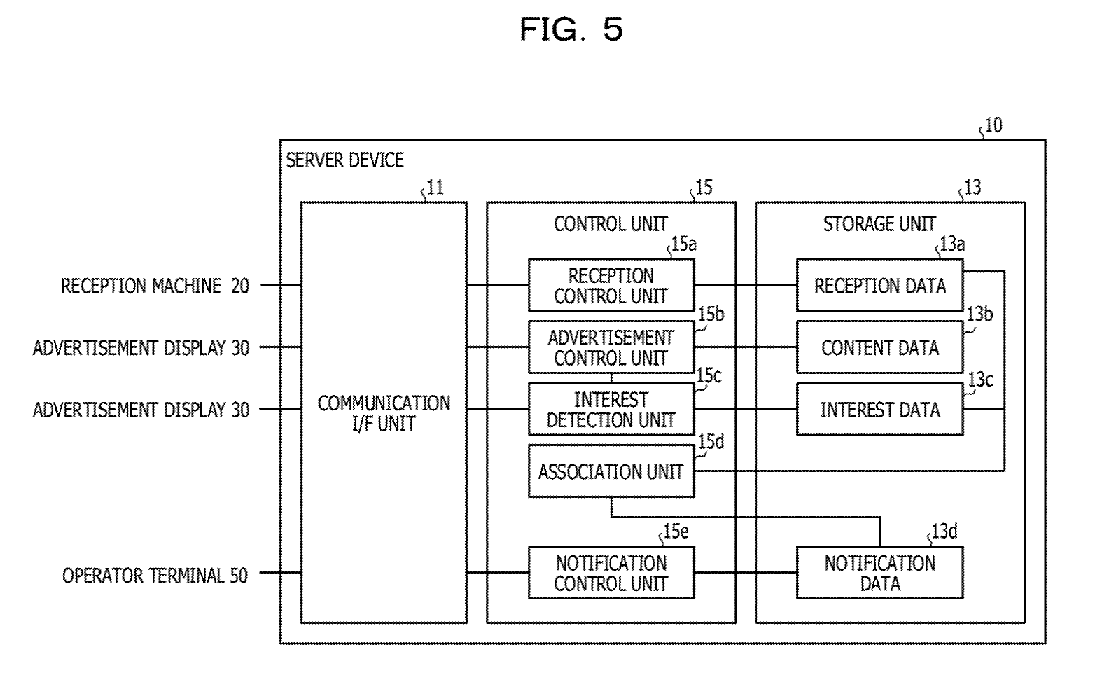

FIG. 5 is a block diagram illustrating a functional configuration of the server device 10 according to the first embodiment. As illustrated in FIG. 5, the server device 10 includes a communication interface (I/F) unit 11, a storage unit 13, and a control unit 15. In this regard, the server device 10 may include various functional units possessed by a known computer, for example functional units of various input and output devices, an audio output device, an image pickup device, or the like in addition to the functional units illustrated in FIG. 5.

The communication I/F unit 11 is an interface that performs communication control with another device, for example, the reception machine 20, the advertisement display 30, and the operator terminal 50.

As an embodiment, it is possible to employ a network interface card, such as a LAN card, or the like for the communication I/F unit 11. For example, the communication I/F unit 11 receives a notification of a reception event from the reception machine 20, or a sight line position from the advertisement display 30. Also, the communication I/F unit 11 transmits an image pickup instruction to the reception machine 20 and the advertisement display 30. Also, the communication I/F unit 11 transmits an output instruction of a voice guidance that guides to a window and a notification regarding a product that interests a customer who has visited a window the like to the operator terminal 50.

The storage unit 13 is a device that stores various programs, such as an operating system (OS) executed on the control unit 15 and application programs including a window reception program that realizes the above-described window reception services, and the like, and the data used by the programs.

As an embodiment, the storage unit 13 is implemented as a main storage device in the server device 10. For example, it is possible to employ various semiconductor memory devices, for example a random access memory (RAM) or a flash memory for the storage unit 13. Also, it is possible to implement the storage unit 13 as an auxiliary storage device. In this case, it is possible to employ a hard disk drive (HDD), a solid state drive (SSD), an optical disc, or the like.

The storage unit 13 stores reception data 13a, content data 13b, interest data 13c, notification data 13d, and the like as an example of data used by the programs executed by the control unit 15. It is possible to store the other electronic data, for example, information, such as a queue of the reception numbers, or the like in addition to the reception data 13a, the content data 13b, the interest data 13c, and the notification data 13d. In this regard, descriptions will be given of the reception data 13a, the content data 13b, the interest data 13c, and the notification data 13d with the description of the control unit 15.

The control unit 15 includes an internal memory that stores various programs and control data, and executes various kinds of processing by these.

As an embodiment, the control unit 15 is implemented as a so-called central processing unit (CPU). In this regard, the control unit 15 does not have to be implemented as a central processing unit, and may be implemented as a micro processing unit (MPU). Also, it is possible to realize the control unit 15 by hardwired logic, such as an application specific integrated circuit (ASIC), a field programmable gate array (FPGA), or the like.

The control unit 15 executes various programs so as to virtually realize the following processing unit. For example, as illustrated in FIG. 5, the control unit 15 includes a reception control unit 15a, an advertisement control unit 15b, an interest detection unit 15c, an association unit 15d, and a notification control unit 15e.

The reception control unit 15 is a processing nit that performs control of the reception machine 20.

As an embodiment, when the reception machine 20 has notified the reception control unit 15a of the occurrence of a reception event, the reception control unit 15a gives an image pickup instruction to the reception machine 20. After that, when the reception machine 20 has uploaded a reception number, a service, and a face image, the reception control unit 15a adds an entry associated with the face image captured by the camera 22 of the reception machine 20, the reception number, and the service to the reception data 13a stored in the storage unit 13 so as to create a record of the reception data 13a.

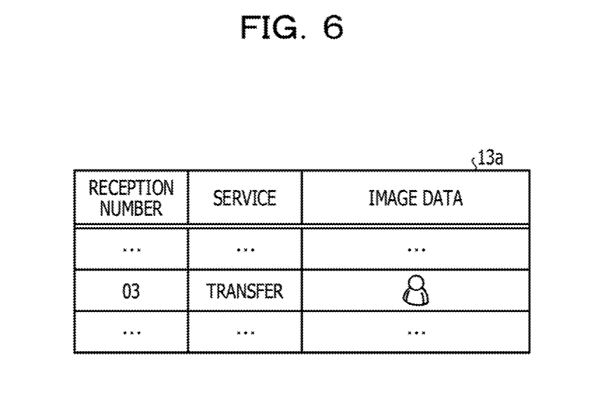

FIG. 6 is a diagram illustrating an example of the reception data 13a. FIG. 6 illustrates a record regarding the customer 2 illustrated in FIG. 2 as an excerpt. As illustrated in FIG. 6, as an example, data associated with a reception number, a service, and an image is employed for the reception data 13a. The example in FIG. 6 represents that the customer 2 illustrated in FIG. 2 has visited the sales office in order to carry out transfer at a window, and a number ticket T, on which a reception number “3” assigned to the customer 2 was printed, has been issued. In this manner, the face image of the customer 2, whose waiting turn at a window was received by the reception machine 20, is stored in the reception data 13a.

The advertisement control unit 15b is a processing unit that performs display control of the advertisement display 30.

As an embodiment, the advertisement control unit 15b reads the advertisement content of each product stored as the content data 13b from the storage unit 13 in accordance with a predetermined order, and displays the advertisement content of the read product on the advertisement display 30. As an example of the content data 13b, the advertisement content illustrated in FIG. 3 and FIG. 4 is given. In the examples in FIG. 3 and FIG. 4, the advertisement content regarding A product, the advertisement content regarding B product, and the advertisement content regarding C product are stored in the storage unit 13. It is possible for these pieces of advertisement content to include explanatory text of a product, a still image, a moving image, a link to a related product, and the like, and an area of interest for detecting an interest to the product, for example, the display area of “Here”, and the like. As already described using FIG. 3 and FIG. 4, the advertisement control unit 15b circulates the advertisement content in order of A product, B product, C product, and A product with time. At this time, if the sight line position notified from the small-sized sensor 31 of the advertisement display 30 is on the screen of the advertisement display 30 or in the area of interest set on the advertisement content, it is possible for the advertisement control unit 15b to extend the display period of the advertisement content,

The interest detection unit 15c is a processing unit that detects an interest of the customer to the advertisement display 30.

As an embodiment, the interest detection unit 15c performs the following processing every time a sight line position is notified from the small-sized sensor 31 of the advertisement display 30. That is to say, the interest detection unit 15c determines whether or not a sight line position exists on the screen of the advertisement display 30. At this time, if a sight line position exists on the screen of the advertisement display 30, the interest detection unit 15c determines whether or not the retention period in which the sight line position is retained on the screen of the advertisement display 30 is equal to or longer than a predetermined threshold value, for example, 3 seconds. If the retention period is equal to or longer than the threshold value, the interest detection unit 15c determines whether or not the advertisement content of a product has been changed during the retention period. Next, if the advertisement content of a product has not been changed during the retention period, the interest detection unit 15c further determines whether or not the sight line position exists in a concern area of the advertisement content of the product.

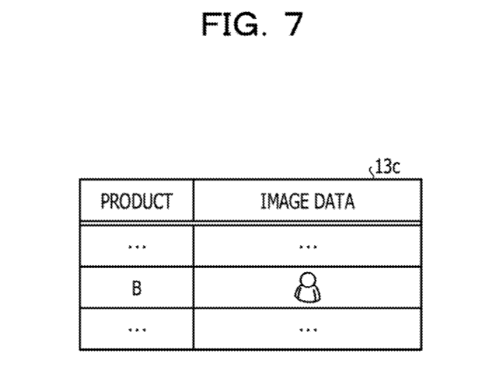

Here, if the sight line position exists in the area of interest in the advertisement content, it is possible to determine that the sight line is derived from an interest in the advertisement content of the product. In this case, the interest detection unit 15c gives an image pickup instruction to the microcomputer included in the small-sized sensor 31. After that, the interest detection unit 15c obtains the face image of a customer captured by the camera included in the small-sized sensor 31 in response to the image pickup instruction. Moreover, the interest detection unit 15c adds an entry that associates the product of the advertisement content having an interest detected with the face image of the customer captured by the small-sized sensor 31 to the interest data 13c stored in the storage unit 13 so as to create a record of the interest data 13c. FIG. 7 is a diagram illustrating an example of interest data 13c. FIG. 7 illustrates the case where an interest in the advertisement content of B product is detected out of the products illustrated in FIG. 3 and FIG. 4.

The association unit 15d is a processing unit that associates a reception number with a product.

As an embodiment, the association unit 15d performs the following processing every time a new record is created in the interest data 13c stored in the storage unit 13. That is to say, the association unit 15d reads the face image of a record that is newly created out of the records included in the above-described interest data 13c. Next, the association unit 15d compares the face image read previously from the interest data 13c with each face image of the reception data 13a stored in the storage unit 13. For example, the association unit 15d calculates a feature vector of the face image read previously from the interest data 13c and the feature vector of the face image for each face image of the reception data 13a. Moreover, the association unit 15d determines whether or not there is a feature vector of each face image of the reception data 13a, which has the distance shorter than or equal to a predetermined threshold value with the feature vector of the face image that has been read previously from the interest data 13c. At this time, if there is a feature vector having the distance shorter than or equal to the predetermined threshold value with the feature vector of the face image of the interest data 13c among the feature vector of each face image of the reception data 13a, it is possible to identify each other's face image is the face image of the same person. In this case, the association unit 15d associates the product corresponding to the face image read previously of the interest data 13c with the reception number and the service that are associated with the face image of the reception data 13a, which is of the same person of the face image of the interest data 13c. Moreover, the association unit 15d adds the entry corresponding to the reception number associated previously, the service, the product, and the face image to the notification data 13d stored in the storage unit 13 so as to create a record to the notification data 13d. Thereby, the reception number issued by the reception machine 20 is associated with the product in which the customer having the reception number is interested.

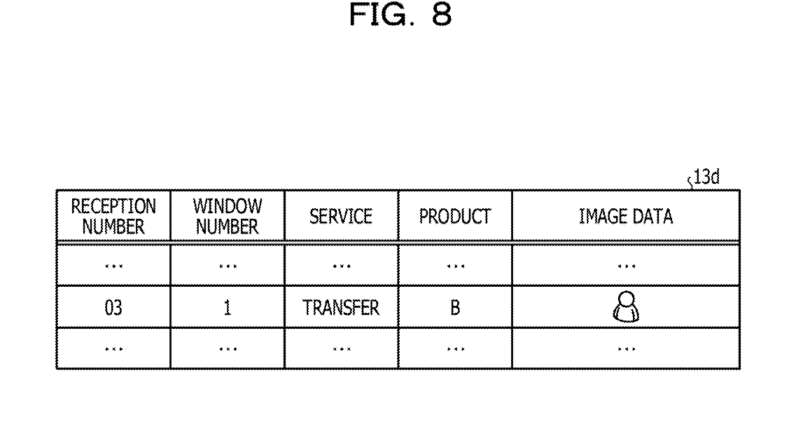

Such notification data 13d is data used for notification to the operator terminal 50. FIG. 8 is a diagram illustrating an example of notification data 13d. For example, if it is assumed that a face image included in the record of the reception data 13a illustrated in FIG. 6 and the face image included in the record of the reception data 13a illustrated in FIG. 7 are of the same person, the record of the reception data 13a illustrated in FIG. 6 is associated with the record of the interest data 13c illustrated in FIG. 7 as illustrated in FIG. 8. Thereby, the reception number “03” of the number ticket T assigned to the customer 2 illustrated in FIG. 2 is associated with B product that has interested the customer 2 illustrated in FIG. 4 by the display of the advertisement content in the advertisement display 30 during the waiting time. In this regard, the field of the window number illustrated in FIG. 8 is set to blank until the waiting turn of the reception number “03” in the queue ends.

The notification control unit 15e is a processing unit that performs notification control of the operator terminal 50.

As an embodiment, the notification control unit 15e performs the following processing every time a vacancy of any one of the windows occurs, that is to say, every time the number calling operation device of the operator terminal 50 performs a calling operation of a reception number. That is to say, the notification control unit 15e assigns the beginning reception number of the queue to the operator terminal 50 that has performed the calling operation of the reception number. Thereby, the reception number displayed on the number display device of the operator terminal 50 is updated to the beginning reception number of the queue. Next, the notification control unit 15e sets the window number of the operator terminal 50 in the field of the window number of the record having the same number as the reception number assigned to the operator terminal 50 out of the records included in the notification data 13d stored in the storage unit 13. Moreover, the notification control unit 15e outputs a voice announcement that guides a customer having the number ticket of the reception number assigned to the operator terminal 50 by which the calling operation of the reception number has been performed via any speaker not illustrated in the figure, for example, a speaker disposed at least one of the sales office, the operator terminal 50, the reception machine 20, and the advertisement display 30. Next, out of the records included in the above-described notification data 13d, the notification control unit 15e notifies the operator terminal 50 having the reception number assigned of the product of the record having the assigned reception number to the operator terminal 50, and further the face image. Thereby, in the example in FIG. 8, it is possible for the operator to grasp that the customer 2 having the number ticket T of the reception number “03” is interested in B product. Accordingly, it becomes possible to perform window sales, such as distributing brochures of B product, or explaining the selling points and the supplementary items.

Processing Flow

Next, a description will be given of the processing flow of the window reception system according to the present embodiment. In this regard, here a description will be given first of 1. reception control processing performed between the server device 10 and the reception machine 20, and then in order of 2. interest detection processing, 3. association processing, and 4. notification control processing that are performed by the server device 10.

1. Reception Control Processing

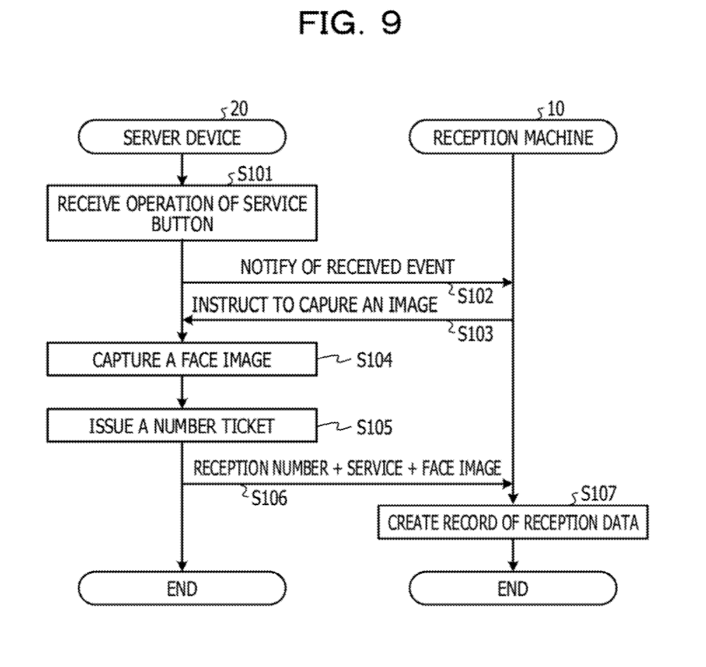

FIG. 9 is a diagram illustrating a sequence of reception control processing according to the first embodiment. As illustrated in FIG. 9, when any one of a plurality of services is selected on the service selection screen displayed on the touch panel 21 (step S101), the reception machine 20 transmits the occurrence of a reception event to the server device 10 (step S102). In this manner, the reception control unit 15a of the server device 10 notified of the occurrence of the reception event from the reception machine 20 gives an image pickup instruction to the reception machine 20 (step S103).

Upon receiving this, the reception machine 20 causes the camera 22 to perform shutter control to capture the image of the customer 2 who has operated the reception machine 20 while standing in front of the screen of the touch panel 21 (step S104). Based on that, the reception machine 20 increments the number of people waiting at the window, and issues a number ticket T on which the reception number corresponding to the number of people after the increment is printed (step S105). After that, the reception machine 20 uploads the reception number, the service, and the face image to the server device 10 via the network 7 (step S106).

The reception control unit 15a then adds an entry associated with the face image captured by the camera 22 of the reception machine 20, the reception number, and the service to the reception data 13a stored in the storage unit 13 so as to create a record of the reception data 13a (step S107), and terminates the processing.

2. Interest Detection Processing

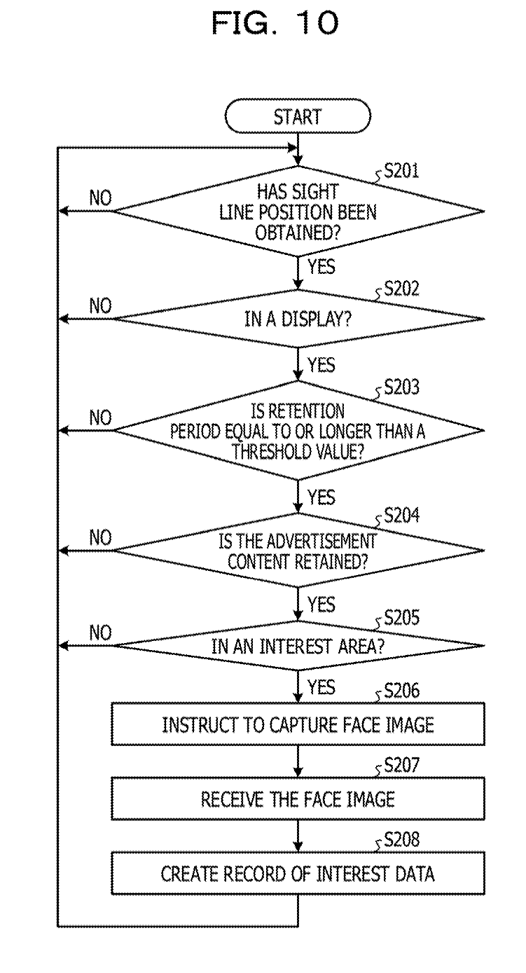

FIG. 10 is a flowchart illustrating a procedure of interest detection processing according to the first embodiment. As illustrated in FIG. 10, when a sight line position is obtained from the small-sized sensor 31 of the advertisement display 30 (Yes in step S201), the interest detection unit 15c determines whether or not a sight line position exists on the screen of the advertisement display 30 (step S202).

At this time, if a sight line position exists on the screen of the advertisement display 30 (Yes in step S202), the interest detection unit 15c determines whether or not the retention period in which the sight line position retains on the screen of the advertisement display 30 is equal to or longer than a predetermined threshold value, for example, three seconds (step S203).

If the retention period is equal to or longer than the threshold value (Yes in step S203), the interest detection unit 15c further determines whether or not the advertisement content of a product has been retained during the retention period (step S204). Next, if the advertisement content of a product has been retained during the retention period (Yes in step S204), the interest detection unit 15c further determines whether or not the sight line position of the product exists in the area of interest of the advertisement content (step S205).

Here, if the sight line position exists in the area of interest of the advertisement content (Yes in step S205), it is possible to determine that the sight line derives from an interest in the advertisement content of the product. In this case, the interest detection unit 15c gives an image pickup instruction to the microcomputer mounted on the small-sized sensor 31 (step S206).

After that, the interest detection unit 15c obtains the face image of the customer, which has been captured by the camera mounted on the small-sized sensor 31 in response to the image pickup instruction (step S207). Based on this, the interest detection unit 15c adds an entry that associates the product in which an interest in the advertisement content is detected and the face image of the customer whose image is captured by the small-sized sensor 31 to the interest data 13c stored in the storage unit 13 so as to create a record of the interest data 13c (step S208), and terminates the processing.

3. Association Processing

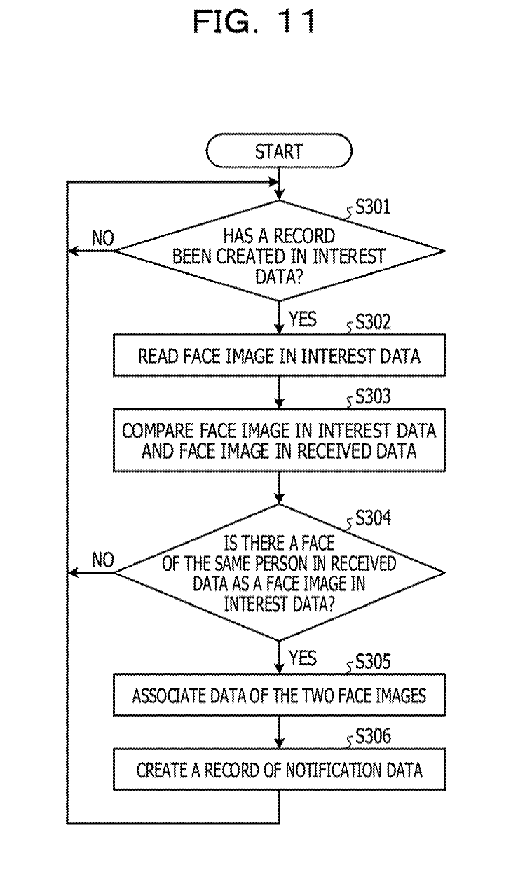

FIG. 11 is a flowchart illustrating a procedure of association processing according to the first embodiment. As illustrated in FIG. 11, when a new record is created in the interest data 13c stored in the storage unit 13 (Yes in step S301), the association unit 15d reads the face image of the newly created record, out of the records included in the interest data 13c (step S302). Next, the association unit 15d compares the face image of the interest data 13c read previously and each face image of the reception data 13a stored in the storage unit 13 (step S303).

Here, if there is a feature vector, out of the feature vector of each face image of the reception data 13a, which has the distance shorter than or equal to a threshold value with the feature vector of the face image of the interest data 13c (Yes in step S304), it is possible to identify that both face images are the face image of the same person. In this case, the association unit 15d associates the product corresponding to the face image of the interest data 13c read in step S302, and the reception number and the service that are corresponding to the face image of the reception data 13a, which is the face image of the same person (step S305).

Moreover, the association unit 15d adds an entry in which the reception number, the service, the product, and the face image are associated in step S305 to the notification data 13d stored in the storage unit 13 so as to create a record of the notification data 13d (step S306), and terminates the processing.

Thereby, the reception number issued by the reception machine 20 is associated with the product that has interested the customer to whom the reception number was issued.

4. Notification Control Processing

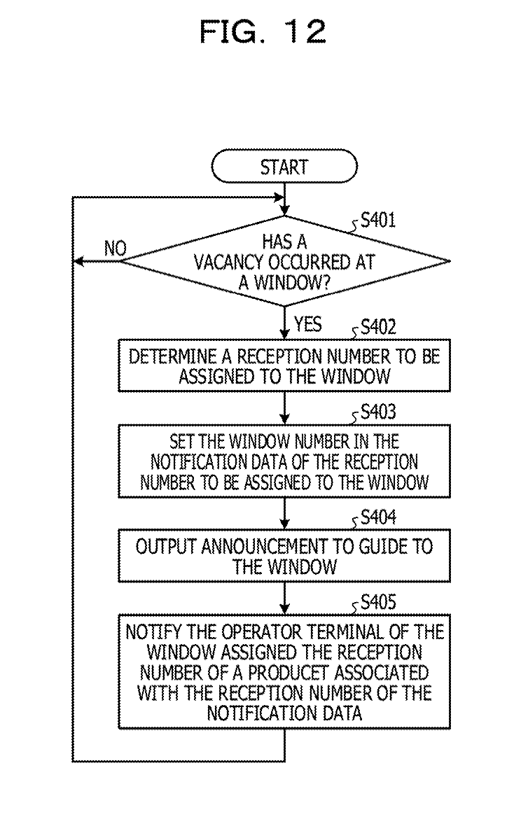

FIG. 12 is a flowchart illustrating a procedure of the notification control processing according to the first embodiment. As illustrated in FIG. 12, if a vacancy occurs in any one of the windows, that is to say, if the number calling operation device of the operator terminal 50 has performed a calling operation of a reception number (Yes in step S401), the notification control unit 15e performs the following processing. That is to say, the notification control unit 15e assigns the beginning reception number of the queue to the operator terminal 50 that performed the calling operation of the reception number (step S402).

Next, the notification control unit 15e sets the window number of the operator terminal 50 in the field of the window number of the record having the same reception number assigned to the operator terminal 50 out of the records included in the notification data 13d stored in the storage unit 13 (step S403).

Based on this, the notification control unit 15e outputs a voice announcement that guides the customer who has a number ticket having the reception number assigned to the operator terminal 50 that has performed the calling operation of the reception number to the window of the operator terminal 50 via any speaker, not illustrated in the figure, which is disposed at least one of the speakers installed at the sales office, the operator terminal 50, the reception machine 20, and the advertisement display 30, for example (step S404).

Next, the notification control unit 15e transmits the product of the record having the reception number assigned to the operator terminal 50 and further the face image out of the records included in the notification data 13d to the operator terminal 50 to which the reception number was assigned (step S405), and terminates the processing.

An Aspect of Advantages

As described above, with the server device 10 according to the present embodiment, if the face image captured when the reception machine 20 issues a reception number and the face image captured when an interest in the product is detected by the advertisement display 30 are of the same person, the reception number and the product are associated, and the product associated with the reception number is notified to the operator terminal 50 to which the reception number was assigned. Accordingly, with the server device 10 according to the present embodiment, it is possible to link the product that has interested a customer during a waiting time at a window to window sales.

### Second Embodiment

In the first embodiment, the case where a reception number and a product are associated using a face image as an index is exemplified. However, it is possible to associate a reception number and a product by another method. Thus, in the present embodiment, a description will be given of the case where by tracking the flow line of a customer having a reception number issued by the reception machine 20, a product having an interest detected on the flow line is associated with a reception number.

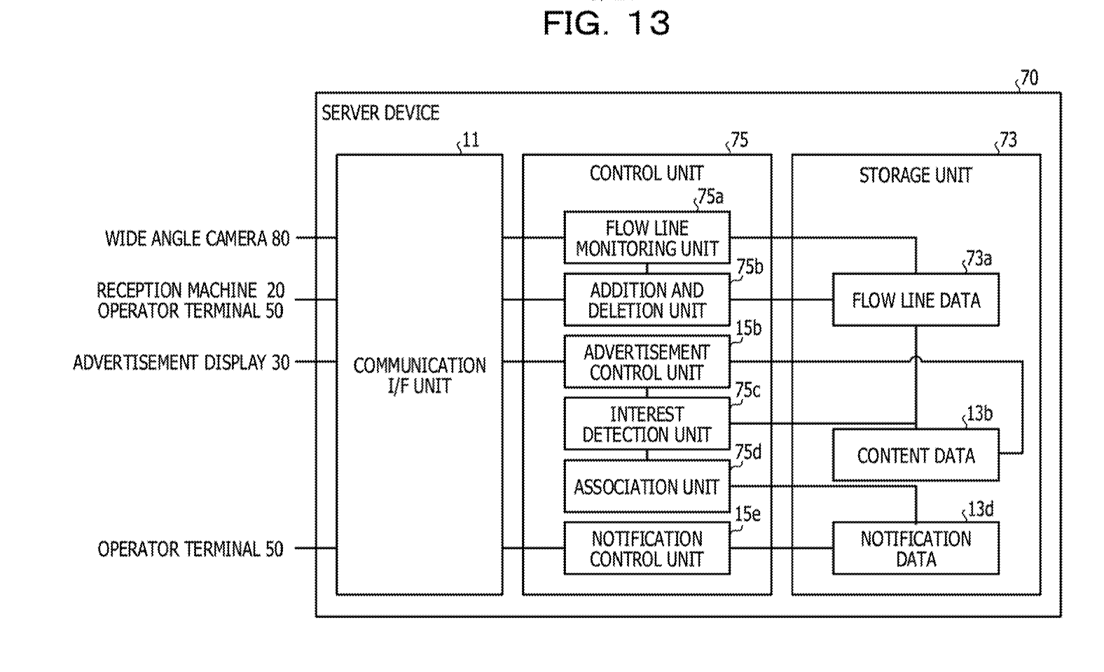

FIG. 13 is a block diagram illustrating a functional configuration of a server device 70 according to a second embodiment. The server device 70 illustrated in FIG. 13 differs from the server device 10 illustrated in FIG. 5 in the following points. For example, the difference is that a wide angle camera 80 is further coupled to the server device 70. Such a wide angle camera 80 is disposed on a ceiling or a wall of a sales office in various mode, for example in an embedded method or a hanging method such that the head of a customer who walks around the reception machine 20, the advertisement display 30, the lobby and the window in the sales office is contained in the image capturing range. In this regard, in FIG. 13, a functional unit having the same function as that of the functional unit illustrated in FIG. 5 is given the same symbol, and the description thereof will be omitted.

Further, the server device 70 is different in the point that the server device 70 includes new data stored in the storage unit 73, for example flow line data 73a, and includes a part of a new processing unit included in the control unit 75, for example a flow line monitoring unit 75a and an addition and deletion unit 75b. In this regard, a description will be given of the flow line data 73a together with the description of the flow line monitoring unit 75a.

The flow line monitoring unit 75a is a processing unit that monitors the flow line of each customer based on images captured by the wide angle camera 80.

As an embodiment, the flow line monitoring unit 75a tracks the position of the head of a customer between frames of the image every time the wide angle camera 80 captures the image so as to monitor the flow line of each customer. That is to say, the flow line monitoring unit 75a tracks the position of the head of a customer between frames of the image captured by the wide angle camera 80 for each reception number of a customer included in the flow line data 73a stored in the storage unit 73, and stores the locus of the position of the head in the flow line data 73a in association with the reception number.

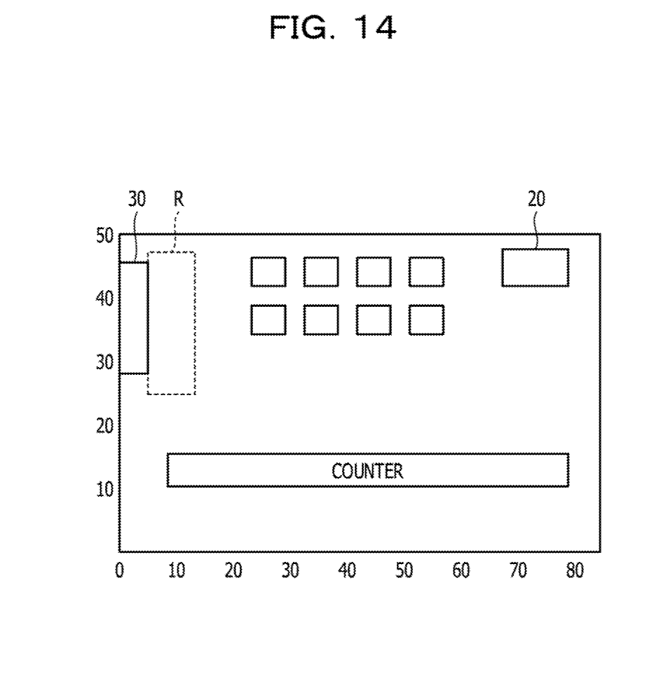

Here, the coordinate system of an image captured by the wide angle camera 80 is used for the coordinates by which the above-described position is identified by the flow line monitoring unit 75a as an example. FIG. 14 is a diagram illustrating an example of an image coordinate system of the wide angle camera 80. In FIG. 14, a coordinate system, in which the lower-left point in the image captured by the wide angle camera 80 is set to the origin, the horizontal direction is set to the X-axis, and the vertical direction is set to the Y-axis, is used as an example. As illustrated in FIG. 14, the lens of the wide angle camera 80 is disposed from the ceiling of a waiting room of a sales office toward the floor surface in the state capable of capturing the entire image of the waiting room including the reception machine 20, the advertisement display 30, and a counter provided with windows. Here, it is possible to automatically set or calibrate the position of the coordinates of the reception machine 20, the position of the coordinates of advertisement display 30, or the like by the image processing in advance using a marker, or the like.

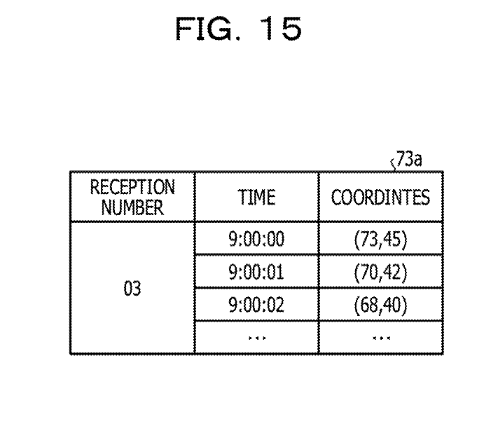

FIG. 15 is a diagram illustrating an example of flow line data 73a. FIG. 15 illustrates a flow line of a customer to whom a number ticket having a reception number of “03” has been issued as an example. The example in FIG. 15 represents that a customer receives a number ticket having a reception number of “03” by the reception machine 20 at 9 o'clock, and the coordinates thereof have changed from (73, 45) to (70, 42), and (68, 40) in two seconds. In this regard, a reception number included the flow line data 73a is added or deleted by the addition and deletion unit 75b described later.

The addition and deletion unit 75b is a processing unit that adds or deletes an entry of a reception number to or from the flow line data 73a.

As an aspect, when the reception machine 20 issues a reception number, the addition and deletion unit 75b adds the entry of the reception number issued by the reception machine 20 to the flow line data 73a stored in the storage unit 73 so as to create a record of the flow line data 73a. Further, the addition and deletion unit 75b associates the customer whose head is detected at the front position of the reception machine 20 at a point in time when the reception number is issued with the above-described reception number, and instructs the flow line monitoring unit 75a to start tracking. Thereby, the flow line monitoring unit 75a monitors the flow line from the next frame of the image captured by the wide angle camera 80.

As another aspect, the addition and deletion unit 75b deletes the entry of the reception number assigned to the operator terminal 50 out of the records of the flow line data 73a stored in the storage unit 73 every time the beginning reception number of the queue is assigned to an operator terminal 50. Further, the addition and deletion unit 75b instructs the flow line monitoring unit 75a to terminate tracking of the customer corresponding to the reception number assigned to the operator terminal 50.

Further, as illustrated in FIG. 13, the server device 70 differs from the server device 10 illustrated in FIG. 5 in the point that, for example parts of the functions performed by an interest detection unit 75c and an association unit 75d in the processing unit in the control unit 75 are different.

In contrast with the interest detection unit 15c illustrated in FIG. 5, the interest detection unit 75c detects a customer's interest in the product by the fact of whether or not the head position of the customer who is monitored by the flow line monitoring unit 75a is retained in a predetermined area of interest in place of the sight line position obtained from the advertisement display 30.

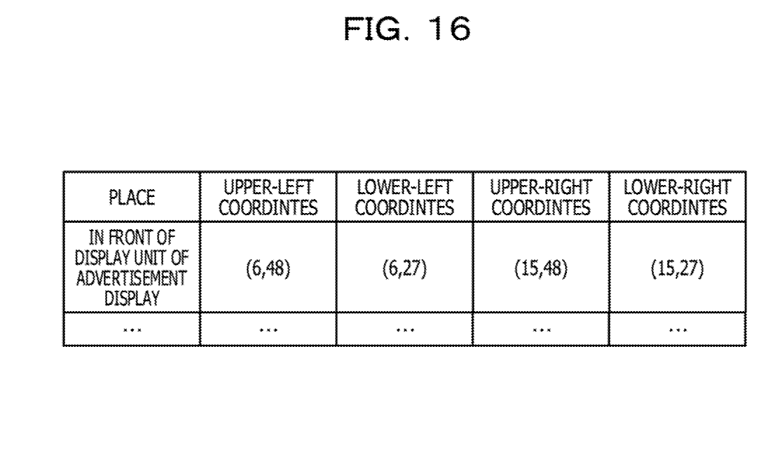

For such an area of interest, as an example, a viewable range of the medium on which advertisement content is displayed is set. It is possible to employ not only a visible range, but a distinguishable range of the character string displayed on the advertisement content by, for example an eyesight 0.7, 1.0, or the like including correction using glasses, contact lenses, or the like. Here, it is assumed that as an example, a distinguishable range of the advertisement content of a product displayed by the advertisement display 30 is set to the area of interest. FIG. 16 is a diagram illustrating an example of an area of interest. FIG. 16 illustrates the area of interest R that is set in front of the advertisement display 30 in the image coordinate system illustrated in FIG. 14. Such an area of interest R corresponds to the rectangular area indicated by a broken line in the image illustrated in FIG. 14.

As an embodiment, the interest detection unit 75c obtains the latest position of the head out of the position of the head associated with the reception number for each reception number of the flow line data 73a stored in the storage unit 73, and determines whether or not the latest position of the head is included in the above-described area of interest. If the head is included in the area of interest, the interest detection unit 75c determines whether or not the retention period of the head in the area of interest is equal to or longer than a predetermined threshold value, for example 5 seconds.

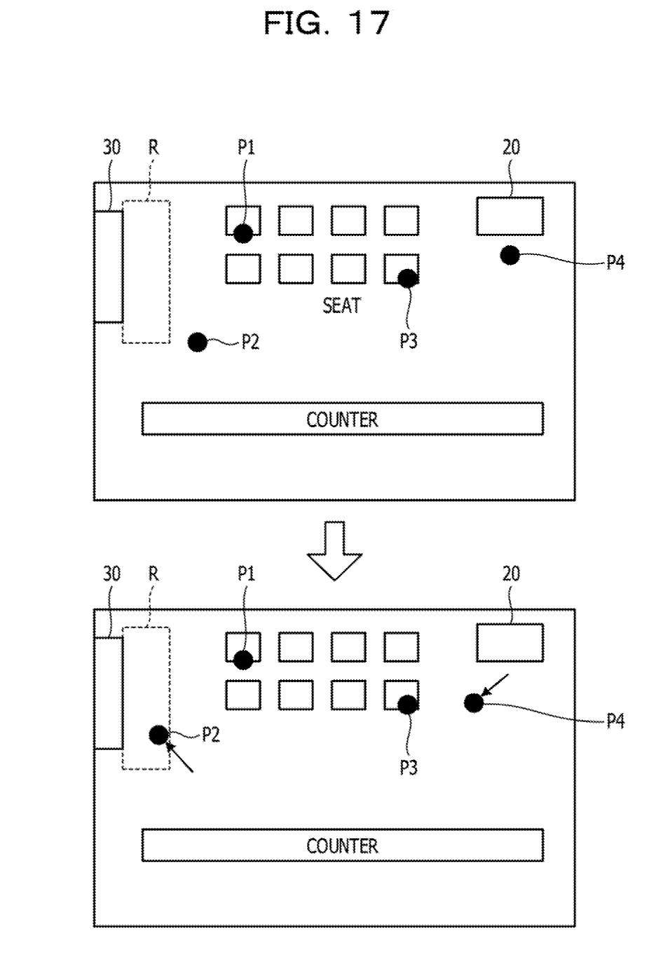

Here, the following description will be given on the assumption that the frame interval of an image captured by the wide angle camera 80 is one second. FIG. 17 is a diagram illustrating an example of interest detection. FIG. 17 illustrates an image captured by the wide angle camera 80. In the upper part of FIG. 17, the image of the frame N is illustrated, whereas in the lower part of FIG. 17, the image of the frame N+2, that is to say, the image of two second after the frame N is illustrated. Further, in FIG. 17, the latest position of the head of the reception number included in the flow line data 73a is plotted by a black circle, and when there is a movement between the frame N and the frame N+2, the movement of the head is illustrated by an arrow.

As illustrated in FIG. 17, the head P2 and the head P4 have moved among heads P1 to P4 during a period from frame N to frame N+2. Among these, the movement of the head P4 corresponds to the flow line having the reception number “03” in the flow line data 73a illustrated in FIG. 15. That is to say, it is understood that the customer to whom a number ticket having the reception number “03” was issued has moved in the lower left direction in the image coordinate system from the front of the reception machine 20. On the other hand, the head P2 was outside of the area of interest R at a stage of frame N, but has entered the area of interest R at a stage of frame N+2. In this case, the interest detection unit 75c monitors the retention period of the head P2 in the area of interest R.

If the retention period is equal to or longer than a threshold value, the interest detection unit 15c further determines whether or not advertisement content of a product has been changed during the retention period. In this manner, if the advertisement content of a product has not been changed during the retention period, it is supposed that the retention in the area of interest derives from an interest in the advertisement content of the product.

In this case, when the interest detection unit 75c detected an interest, the association unit 75d adds an entry that associates the reception number of the head of the customer having the interest detected, and the product that was being displayed on the advertisement display 30 at the point in time when the interest detection unit 75c detected an interest to the notification data 13d stored in the storage unit 13 so as to create a record of the notification data 13d. The association unit 75d is capable of storing a service corresponding to the reception number in addition.

In this manner, when notification data 13d is created, it is possible to carry out notification to the operator terminal 50 in the same manner as the first embodiment.

Processing Flow

Next, a description will be given of the processing flow of the server device 70 according to the present embodiment. In this regard, here a description will be given of (1) management processing of flow line data, and then a description will be given of (2) association processing that are performed by the server device 70.

(1) Management Processing of Flow Line Data

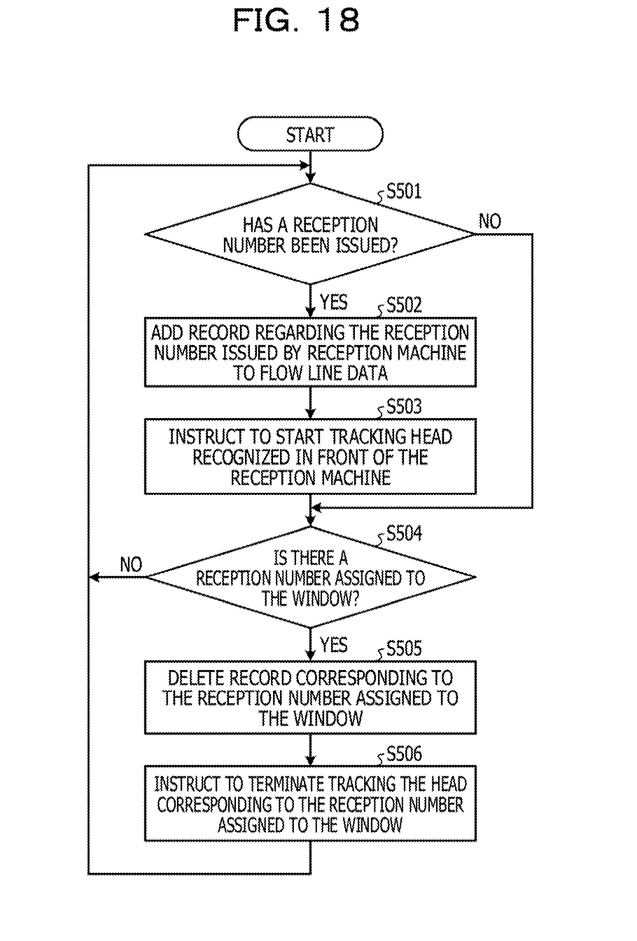

FIG. 18 is a flowchart illustrating a procedure of the management processing of flow line data, according to the second embodiment. As an example, this processing is repeatedly performed while the power source to the reception machine 20 and the advertisement display 30 is in the on state.

As illustrated in FIG. 18, when the reception machine 20 issues a reception number (Yes in step S501), the addition and deletion unit 75b adds an entry of the reception number issued by the reception machine 20 to the flow line data 73a stored in the storage unit 73 so as to create a record of the flow line data 73a (step S502).

Further, the addition and deletion unit 75b links a customer whose head is detected in the front position of the reception machine 20 at a point in time when the reception number was issued with the above-described reception number, and instructs the flow line monitoring unit 75a to start tracking (step S503). In this regard, if the reception machine 20 has not issued a reception number (No in step S501), the processing skips the processing of step S502, and step S503 and proceeds to the processing in step S504.

Also, if the beginning reception number of the queue is assigned to the operator terminal 50 (Yes in step S504), the addition and deletion unit 75b deletes the entry of the reception number assigned to the operator terminal 50 among the records of the flow line data 73a stored in the storage unit 73 (step S505). Further, the addition and deletion unit 75b instructs the flow line monitoring unit 75a to terminate tracking of the customer corresponding to the reception number assigned to the operator terminal 50 (step S506). In this regard, if the beginning reception number of the queue is not assigned to the operator terminal 50 (No in step S504), processing returns to step S501.

(2) Association Processing

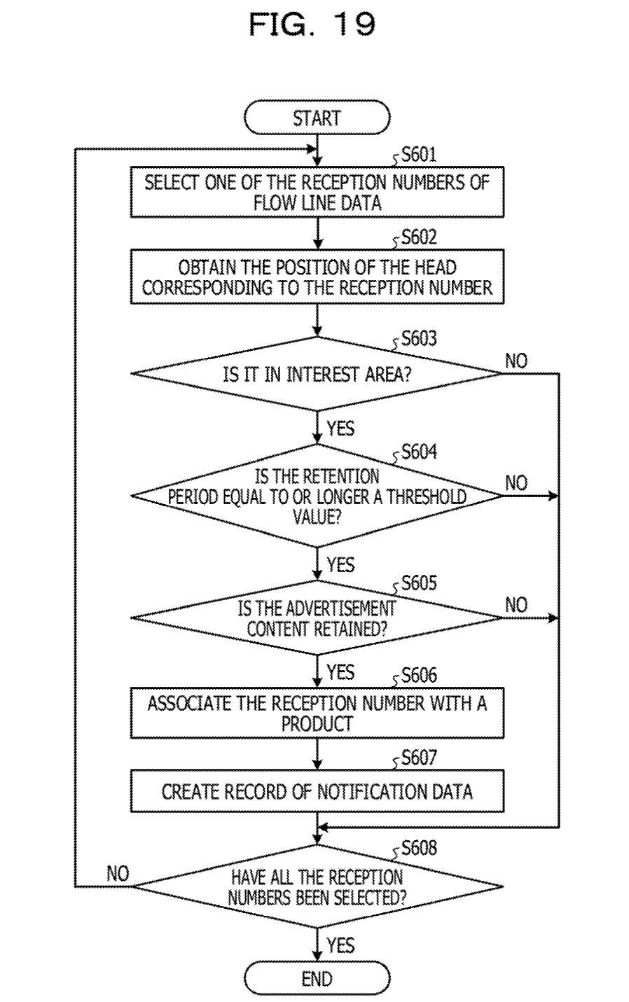

FIG. 19 is a flowchart illustrating a procedure of the association processing according to the second embodiment. As illustrated in FIG. 19, the interest detection unit 75c selects one reception number out of the reception numbers of the flow line data 73a stored in the storage unit 73 (step S601). Next, the interest detection unit 75c obtains the latest position of the head out of the positions of the head associated the reception number selected in step S601 (step S602).

The interest detection unit 75c then determines whether or not the latest position of the head obtained in step S602 is included in the area of interest (step S603). At this time, if the head is included in the area of interest (Yes in step S603), the interest detection unit 75c further determines whether or not the retention period in which the head retains in the area of interest is equal to or longer than a predetermined threshold value, for example 5 seconds (step S604).

Next, if the retention period is equal to or longer than the threshold value (Yes in step S604), the interest detection unit 75c further determines whether or not the advertisement content of a product has been changed during the retention period (step S605).

Here, if the advertisement content of the product has not been changed during the retention period (Yes in step S605), it is supposed that the retention in the area of interest derives from an interest in the advertisement content of the product.

In this case, the association unit 75d associates the reception number corresponding to the head of the customer whose interest was detected in the determination of Yes in step S605 and the product that was displayed on the advertisement display 30 at a point in time when the interest was detected by the determination of Yes in step S605 (step S606). Based on this, the association unit 75d adds the entry that associates the reception number and the product to the notification data 13d stored in the storage unit 13 so as to create a record of the notification data 13d (step S607).

On the other hand, if the head is not included in the area of interest, or if the retention period is not equal to or longer than a threshold value, or if advertisement content of the product was changed during the retention period (No in step S603, No in step S604 or No in step S605), association of the reception number with the product is not carried out, and the processing proceeds to step S608.

Until all the reception numbers included in the flow line data 73a have been selected (No in step S608), the processing from step S601 to step S607 is repeatedly performed. After that, if all the reception numbers included in the flow line data 73a have been selected (Yes in step S608), the processing is terminated.

An Aspect of Advantages

As described above, the server device 70 according to the present embodiment tracks the flow line of the customer to whom a reception number has been issued by the reception machine 20 so as to associate the product in which an interest is detected on the flow line with the reception number being tracked. Accordingly, with the server device 70 according to the present embodiment, it is possible to notify the operator terminal 50 to which the reception number was assigned of the product associated with the reception number. Accordingly, with the server device 70 according to the present embodiment, it is possible to link the product in which a customer has been interested during a waiting time at a window with window sales in the same manner as the first embodiment.

### Third Embodiment

Now, descriptions have been given of the disclosed devices according to the embodiments. However, the present disclosure may be carried out in various modes in addition to the embodiments described above. Thus, in the following, a description will be given of the other embodiments included in the present disclosure.

Product Advertisement Method

In the first embodiment and the second embodiment, descriptions have been given of the examples of the case where the advertisement content of a product is displayed on the advertisement display. However, the product advertisement does not have to be realized by a display device displaying the advertisement content of a product. For example, product advertisement may be realized in the mode in which a printed matter on which the advertisement content of a product is printed, for example a wall-mounted advertisement or the like, may be exhibited. Also, in the first embodiment and the second embodiment described above, an example of the case where the product advertisement is carried out at one place by the advertisement display 30 is given. However, the product advertisement may be carried out at a plurality of places.

Distribution and Integration

Also, each element illustrated in the figures does not have to be physically configured as illustrated in the figures. That is to say, a specific mode of each device is not limited to that illustrated in the figure. It is possible to configure all of or a part of each device by functionally or physically distributing or integrating by any unit in accordance with various loads, use states, and the like. For example, the reception control unit 15a, the advertisement control unit 15b, the interest detection unit 15c, the association unit 15d, or the notification control unit 15e, illustrated in FIG. 5, may be coupled as an external device of the server device 10 via a network. Also, the flow line monitoring unit 75a, the addition and deletion unit 75b, the advertisement control unit 15b, the interest detection unit 75c, the association unit 75d, or the notification control unit 15e, illustrated in FIG. 13, may be coupled as an external device of the server device 70 via a network. In addition, the reception control unit 15a, the advertisement control unit 15b, the interest detection unit 15c, the association unit 15d or the notification control unit 15e, illustrated in FIG. 5, may be individually possessed by separate devices, and cooperate by being coupled via a network to realize the functions of the server device 10 described above. Also, the flow line monitoring unit 75a, the addition and deletion unit 75b, the advertisement control unit 15b, the interest detection unit 75c, the association unit 75d, or the notification control unit 15e, illustrated in FIG. 13, may be individually possessed by separate devices, and cooperate by being coupled via a network to realize the functions of the server device 70 described above.

Notification Control Program

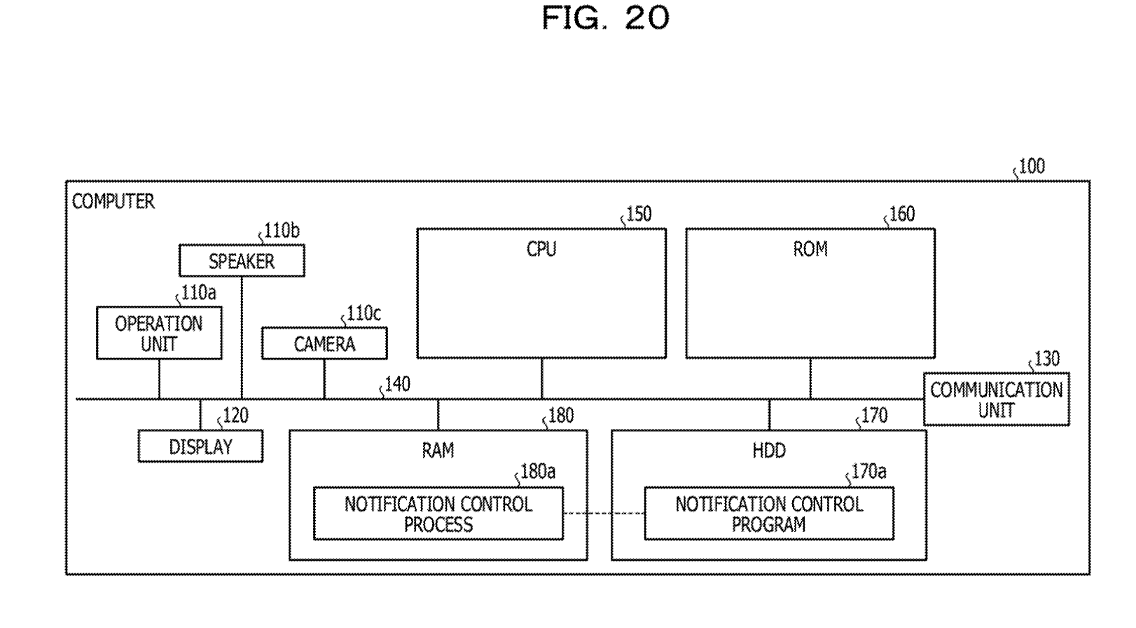

Also, it is possible to realize various kinds of processing described in the embodiments described above by executing a program provided in advance on a computer, such as a personal computer, a workstation, or the like. Thus, in the following, a description will be given using FIG. 20 of an example of a computer that executes a notification control program having the same functions as those of the embodiments described above.

FIG. 20 is a diagram illustrating an example of a hardware configuration of a computer that executes the notification control program according to the first to the third embodiments. As illustrated in FIG. 20, a computer 100 includes an operation unit 110a, a speaker 110b, a camera 110c, a display 120, and a communication unit 130. Further, the computer 100 includes a CPU 150, a ROM 160, an HDD 170, and a RAM 180. Each of the units 110 to 180 are mutually coupled via a bus 140.

As illustrated in FIG. 20, the HDD 170 stores a notification control program 170a that performs the same functions as those of each processing unit possessed by the control unit 15 illustrated in the first embodiment. Also, the notification control program 170a may perform the same functions as those of each processing unit possessed by the control unit 75 illustrated in the second embodiment. The notification control program 170a may be integrated or separated in the same manner as each processing unit possessed by the control unit 15 illustrated in FIG. 5, or each processing unit possessed by the control unit 75 illustrated in FIG. 13. That is to say, the HDD 170 does not have to store all the data illustrated in the first embodiment or the second embodiment, and the data used in the processing ought to be stored in the HDD 170.

Under these circumstances, the CPU 150 reads the notification control program 170a from the HDD 170 and loads the program to the RAM 180. As a result, as illustrated in FIG. 20, the notification control program 170a functions as the notification control process 180a. The notification control process 180a loads various kinds of data that is read from the HDD 170 to an area assigned to the notification control process 180a among the storage area of the RAM 180, and performs various, kinds of processing using the loaded various kinds of data. For example, as an example of the processing performed by the notification control process 180a, the processing illustrated in FIG. 9 to FIG. 12 or FIG. 18 to FIG. 19, or the like is included. In this regard, not all of the processing units illustrated in the first embodiment have to be operated on the CPU 150, and the processing unit corresponding to the processing to be executed ought to be virtually realized.

In this regard, the notification control program 170a does not have to be stored in the HDD 170 or the ROM 160 from the beginning. For example, the notification control program 170a is stored in a flexible disk to be inserted to the computer 100, or a “portable physical medium”, such as an FD, a CD-ROM, a DVD disc, a magneto optical disk, an IC card, or the like. The computer 100 then may obtain the notification control program 170a from these portable physical media and execute the program. Also, the notification control program 170a may be stored in another computer, a server device, or the like via a public line, the Internet, a LAN, a WAN, or the like, and the computer 100 may obtain the notification control program 170a from these and execute the program.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A computer-implemented method executed by a processor, the computer-implemented method comprising:
receiving a request from a user for a first product via a terminal installed on a place;
allocating identification information to the user;
tracking a user movement of the user during a time period between when the request is received and when the first product is provided to the user;
identifying a second product that interests the user based on the tracked user movement, a plurality of product including the second product being presented to the user during the time period;
associating the second product that interest the user with the identification information; and
controlling a display device to display information regarding the second product, the display device being allocated to the identification information of the user.

2. The computer-implemented method according to claim 1, wherein the identification information indicates a user order within a queue of users in the place.

3. The computer-implemented method according to claim 1, further comprising:
acquiring an image of the user when the request for the first product is received; and
creating an reception data entry within a reception data table associating the identification information, the image of the user, and the first product.

4. The computer-implemented method according to claim 3, wherein the tracking of the user movement is executed using the image of the user.

5. The computer-implemented method according to claim 4, further comprising:
acquiring another image of a second user when it is determined that the second user is interested in the second product;
creating an interest data table including the information of the second product and the other image of the second user;
comparing the image of the user to the other image of the second user; and
creating notification data when it is determined that the user in the image matches the second user in the another image, the notification data including the identification information, image of the user, information of the first product, and information of the second product.

6. The computer-implemented method according to claim 5, wherein
the plurality of products is displayed on an advertising device, and
the notification data links interest in the second product to advertising displayed on the advertising device during the time period.

7. The computer-implemented method according to claim 4, wherein
the tracking of the user movement includes:
tracking head positions of the user during the time period using the image of the user and other images captured by at least one of cameras, and
determining whether the user travels into an area of interest of an advertising device which presents a plurality of contents corresponding to the plurality of products based on the tracked head positions, and
the identifying of the second product that interests the user includes:
determining the user stays within the area of interest for a retention period and that a content, from among the plurality of contents, displayed on the advertising device does not change during the retention period, and
identifying the content displayed on the advertising device during the retention period in which the user remained in the area of interest as the second product that interests the user.

8. The computer-implemented method according to claim 1, wherein
the tracking of the user movement includes:
capturing images of an eye of the user, and
determining, based on the images, sight line positions on a screen of an advertising device which presents a plurality of contents corresponding to the plurality of products, and
the identifying of the second product that interests the user includes:
determining whether the sight line positions corresponds to a target area on the advertising device for a duration equal to a retention period, and
identifying content, from among the plurality of contents, associated with the target area as the second product that interests the user when the determining determines the sight line positions correspond to the target area for the duration equal to the retention period.

9. The computer-implemented method according to claim 1, wherein each of the first product and the second product include physical products, services or a combination of products and services provided by a business.

10. A system comprising:
a first device installed on a place and including first circuitry configured to:
receive a request for a product or service from a user who check-in the place and has to wait to receive the product or service, and
allocate identification information to the user; and
a second device including second circuitry configured to:
track line-of-sights of the user to a plurality of content to be provided to the user at the place during a waiting time for the product or service,
identify a content that the user is interested n based on the tracked line-of sights, the content being from among the plurality of contents,
associate the identification information and the identified content, and
control a display device to display information regarding the content when the user receive the product or service, the display device being allocated to the identification information of the user.

11. A system comprising:
a first device including:
a first image sensor configured to capture a first image including a face of a first user, and
a first processor configured to:
generate identification information that identifies the first user included in the image, and
transmit first data including the identification information and the first image to a third device;
a second device including:
a second image sensor configured to capture a plurality of second images including a face of a second user,
a second display device configured to display a plurality of pieces of content, and
a second processor configured to:
track a sight line position of the second user based on the plurality of second images,
determine a content to be associated with the second user, from among the plurality of contents, based on a tracking result of the sight line position, and
transmit the content and second data including at least one of second images from among the plurality of second images to the third device;
the third device including:
a memory configured to store the first data and the second data, and
a third processor configured to:
when the first data and the, second data are received, compare the first image included in the first data, and at least one of the second images included in the second data,
determine whether to associate the identification information identifying the first user and the content associated with the second user based on a comparison result, and
when it is determined that the identification information is associated with the content, transmit the identification information and third data including the content to a fourth device as information regarding the first user associated with the identification information; and
the fourth device including:
a fourth display device configured to display information of the content, and
a fourth processor configured to:
obtain the content from the third data, and
display the content on the fourth display device.

12. The system according to claim 11, wherein
the first processor in the first device is configured to:
obtain service information indicating a service input from the first user, and
transmit the first data further including the service information to the third device,
the third processor in the third device is configured to:
when it is determined that the identification information is associated with the content, transmit the third data further including the service information included in the first data to the fourth device, and
the fourth processor in the fourth device is configured to:
display the service information with the content to the fourth display device,

13. The system according to claim 11, wherein
the second device includes a second display device,
the second display device is configured to display the plurality pieces of content at first time intervals, and
the second processor in the second device is configured to;
detect that the sight line position of the second user is retained on the second display device for a predetermined time or more, and
associate the content displayed on the second display device out of the plurality pieces of content at a point in time when the retention of the sight line position is detected with the second user.

14. The system according to claim 13, wherein
the second processor in the second device is configured to;
when the retention of the sight line position is detected, perform control to display the content on the second display device at second time intervals, and
the second time intervals is longer than the first time intervals.

15. The system according to claim 11, wherein the identification number is a number indicating a user order within a queue of users in a place having the first device.

16. The system according to claim 15, wherein the fourth device is operated as an operator at the place.

17. The system according to claim 16, wherein the fourth display displays the content as a product that interests the first user to the operator in charge of the first user.
